(19) United States
(12) Patent Application Publication
(10) Pub. No.: US 2025/0236548 A1
(43) Pub. Date: Jul. 24, 2025

(54) BIOMINERALIZATION OF PRODUCED WATER

(71) Applicant: SAUDI ARABIAN OIL COMPANY, Dhahran (SA)

(72) Inventors: Manar M. AlAhmari, Dhahran (SA); Norah W. Aljuryyed, Dhahran (SA); Fahd I. Alghunaimi, Khobar (SA); Abdulmohsen A. Humam, Dammam (SA); Asma A. Almutairi, Dhahran (SA)

(73) Assignee: SAUDI ARABIAN OIL COMPANY, Dhahran (SA)

(21) Appl. No.: 18/419,311

(22) Filed: Jan. 22, 2024

(51) Int. Cl. C02F 3/34; C02F 1/44; C02F 101/16; C02F 103/10; C09K 8/528; C09K 8/68; E21B 43/26

(52) U.S. Cl. CPC C02F 3/342; C02F 1/441; C09K 8/528; C09K 8/68; C02F 2101/16; C02F 2103/10; C09K 2208/32; E21B 43/26

(57) ABSTRACT

A method of reducing an ionic content of a produced water includes forming a carbonate precipitate in a precipitation unit via reaction of a treatment composition that includes produced water and an EICP solution, thereby producing a treated mixture. Metal cations dissolved in the produced water may react with one or more components of the EICP solution, thereby forming the carbonate precipitate. A system for reducing an ionic content of a produced water includes a precipitation unit configured to form a treated mixture via precipitation of one or more ions from the produced water in the presence of an EICP solution, and one or more separation units in fluid communication with the precipitation unit and configured to separate a precipitate, the EICP solution, one or more additional impurities, or combinations thereof from the treated mixture.

### BACKGROUND

Oil and gas reservoir applications have recently shifted to using alternative water sources (e.g., produced water) for various applications over growing concerns of lack of freshwater sources. Hydraulic fracturing, for example, can require millions of gallons of water per treatment. However, water obtained from an alternative source often contains a high ionic content, which can form precipitates and scale that erodes and blocks pipes. For example, when an untreated produced water is injected downhole, sulfate ions present in rock, formation brine, and injection fluids high in sulfate ion content can react with metallic cations in produced fluid to produce a sulfate scale. In such instances, the formation of sulfate scale and sulfate scale deposition indicates the incompatibility of untreated produced water for drilling operations. This sulfate scale (or “sulfate precipitate”) formation and deposition may occur in the wellbore or near the wellbore area, and it often causes formation damage that may offset the performance of drilling and recovery applications.

Accordingly there exists a need for a method for treating an alternative water source for reuse in oil and gas operations.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method of reducing an ionic content of a produced water that may include forming a carbonate precipitate in a precipitation unit via reaction of a treatment composition that includes produced water and an EICP solution, thereby producing a treated mixture. Metal cations dissolved in the produced water may react with one or more components of the EICP solution, thereby forming the carbonate precipitate.

In another aspect, embodiments herein relate to a system for reducing an ionic content of a produced water. The system may include a precipitation unit configured to form a treated mixture via precipitation of one or more ions from the produced water in the presence of an EICP solution, and one or more separation units in fluid communication with the precipitation unit and configured to separate a precipitate, the EICP solution, one or more additional impurities, or combinations thereof from the treated mixture.

Other aspects and advantages of the claimed subject matter will be apparent from the following description and the appended claims.

### BRIEF DESCRIPTION OF DRAWINGS

FIG. 1 is a system for reducing an ionic content of a produced water in accordance with one or more embodiments.

FIG. 2 is a non-limiting method for reducing an ionic content of a produced water in accordance with one or more embodiments.

FIG. 3 is a non-limiting schematic example of a reservoir treatment for a well in accordance with one or more embodiments.

FIG. 4 is an X-ray Diffraction (XRD) pattern for a first precipitate sample and corresponding phase identification.

FIG. 5 is an XRD pattern for a second precipitate sample and corresponding phase identification.

FIG. 6 is an XRD pattern for a third precipitate sample and corresponding phase identification.

### DETAILED DESCRIPTION

Produced water is often reused in the oil and gas industry to conserve freshwater. One of the major challenges with the use of produced water in oil and gas operations is its high content of ions, such as metallic cations, that can form scale that can erode and block pipes, which renders it unusable in upstream operations. The term “produced water” is defined as any aqueous fluid that is produced from a well in oil and gas operations, such as water that occurs naturally within a rock (such as formation water) or water trapped in a rock during its formation (such as connate water), which may be produced from a well. The produced water may also include any brine, brackish water, and combinations thereof. Thus, ions must be removed or precipitated out from produced water in order to reliably use produced water in further oil and gas operations without traditional complications.

Produced water often contains high concentrations of ions such as magnesium, calcium, barium, strontium, sodium, potassium, and the like. Therefore, reuse of produced water recovered from a formation in upstream operations can lead to scale formation that blocks and corrodes pipes and subsequently affects wellbore production. To eliminate the formation of scale and ensure safe oil and gas production, ions must be removed or precipitated out from produced water.

In general, conventional water treatment techniques include physical processes, such as filtration, sedimentation, distillation, biological processes, such as slow sand filters or biologically active carbon, chemical processes, such as flocculation and chlorination, and the use of electromagnetic radiation (e.g., ultraviolet light). Embodiments disclosed herein do not require polymers, organic solvents, resins, or bacteria and corresponding nutrients required for their growth.

Embodiments in accordance with the present disclosure generally relate to compositions and methods for reducing ionic content of produced water using Enzyme Induced Carbonate Precipitation (EICP) in combination with additives to recycle produced water for upstream processes. One or more embodiments herein relate to the conservation of groundwater by re-using hyposaline produced water, which promotes water circularity in which a treated produced water can be recycled for use in upstream operations. The treatment compositions, treatment systems, and methods described herein may be configured to remove or reduce ions from produced water. Treatment compositions and methods herein may include simple, economically and environmentally friendly biological treatment agents. In particular, the biological treatment agents may be configured to perform EICP to decrease the concentration of ions in produced water.

### EICP Solution Composition

One or more embodiments of the present disclosure relate to an aqueous treatment composition including an EICP solution that is capable of hydrolyzing urea with a urease enzyme in an aqueous solution and forming carbonic acid and ammonia. The aqueous EICP solution is a homogenous mixture of different additives (i.e., a plurality of components). The plurality of components may include urea, one or more polysaccharides, casein protein, protease, an ionic compound, and a urease.

In one or more embodiments, the aqueous EICP solution includes urea. Urea is an organic compound of the chemical formula CO(NH₂)₂. Urea is a colorless, odorless, water soluble substance with low toxicity (e.g, LD₅₀=12 g/kg (grams of substance per kilogram of body weight) for mouse, Agrium Material Safety Data Sheet (MSDS)). Any suitable source of urea may be used. In one or more embodiments, the urea is present in the EICP solution at concentrations in a range of from about 0.45 M (moles per liter of aqueous solution) to about 1.55 M urea, such as from about 0.6 M to about 1.4 M, or from about 0.7 M to about 1.3 M, or from about 0.8 M to about 1.2 M. Urea may be present in the EICP solution at a concentration in a range having a lower limit of any one of 0.45 M, 0.5, 0.6, 0.7, 0.8, 0.9, and 1.0 M and an upper limit of any one of 0.7, 0.8, 0.9, 1.0, 1.2, 1.5, and 1.55 M, where any lower limit can be paired with any mathematically compatible upper limit.

In one or more embodiments, the EICP solution includes the enzyme urease. The urease of the solution may be synthetically produced or obtained by extraction from any suitable source, including but not limited to, bacteria, plants, invertebrates, and fungi. In one or more embodiments, a plant derived urease extract may be used. In one or more particular embodiments, the urease included in the EICP solution is a urease enzyme isolated and recovered from a Jack Bean plant. In one or more embodiments, the EICP solution includes urease at concentrations in a range of from about 0.95 g/L (gram per Liter of aqueous solution to about 4.1 g/L, from about 1 g/L to about 4 g/L, or from about 1.5 g/L to about 3.5 g/L, or from about 2 g/L to about 3 g/L. Urease may be present in the EICP solution at a concentration in a range having a lower limit of any one of 0.95 g/L, 1.0, 1.2, 1.5, 1.75, 1.9, 2.0, 2.5, and 3.0 g/L and an upper limit of any one of 2.5, 2.95, 3.0, 3.2, 3.5, 3.8, 3.9, 4.0, and 4.1 g/L, where any lower limit can be paired with any mathematically compatible upper limit.

In one or more embodiments, the polysaccharide of the aqueous EICP solution may comprise xanthan gum, guar gum, or mixtures thereof. In one or more embodiments, the polysaccharide may comprise a galactomannan polysaccharide, such as guar gum, at concentrations in a range of from about 0.45 M to about 1.05 M. The polysaccharide may be present in the EICP solution at a concentration in a range having a lower limit of any one of 0.45 M, 0.5, 0.6, 0.7, 0.75, 0.8, 0.85, 0.9, and 0.95 M and an upper limit of any one of 0.7, 0.75, 0.8, 0.85, 0.9, 0.95, 1.0, and 1.05 M, where any lower limit can be paired with any mathematically compatible upper limit.

In one or more embodiments, the casein protein of the aqueous EICP solution includes a micellar casein protein. The casein protein may be a micellar casein protein. The solution may include casein protein at concentrations in a range of from about 1.95 g/L (gram per liter of aqueous solution) to about 4.05 g/L. The casein protein may be present in the EICP solution at a concentration in a range having a lower limit of any one of 1.95 g/L, 2.0, 2.2, 2.5, 2.75, 2.9, 3.0, and 3.5 g/L and an upper limit of any one of 2.5, 2.95, 3.0, 3.2, 3.5, 3.8, 3.9, 4.0, and 4.05 g/L, where any lower limit can be paired with any mathematically compatible upper limit.

In one or more embodiments, the aqueous solution may include one or more ionic compounds, such as sodium chloride, calcium chloride, or mixtures thereof. The solution may include one or more ionic compounds at concentrations in a range of from about 0.35 g/L (gram per liter of aqueous solution) to about 0.65 g/L. The one or more ionic compounds may be present in the EICP solution at a concentration in a range having a lower limit of any one of 0.35 g/L, 0.38, 0.40, 0.42, 0.45, and 0.5 g/L and an upper limit of any one of 0.55, 0.58, 0.60, 0.62, and 0.65 g/L, where any lower limit can be paired with any mathematically compatible upper limit.

The solution may also include a sugar, one or more sugar derivatives, or mixtures thereof. For example, the solution may include sucrose, one or more sucrose derivatives, or mixtures thereof. The sugar, one or more sugar derivatives, or mixtures thereof at concentrations in a range of from about 0.35 g/L (gram per liter of aqueous solution) to about 0.65 g/L. The sugar, one or more sugar derivatives, or mixtures thereof may be present in the EICP solution at a concentration in a range having a lower limit of any one of 0.35 g/L, 0.38, 0.40, 0.42, 0.45, and 0.5 g/L and an upper limit of any one of 0.55, 0.58, 0.60, 0.62, and 0.65 g/L, where any lower limit can be paired with any mathematically compatible upper limit.

Furthermore, the solution may also include a protease, for example, a protease that may be obtained from Aspergillus niger or Aspergillus oryzae. In some embodiments, the protease includes a protease obtained from Aspergillus niger, Aspergillus oryzae, or combinations thereof. For example, the protease may include Aminogen® (commercially available from Innophos), which is a mixture of proteases obtained from Aspergillus niger and Aspergillus oryzae. Aminogen® is a protein digesting enzyme (protease) that catalyzes the breakdown of proteins into smaller polypeptides or amino acids by breaking the peptide bonds between the amino acids. The solution may include a protease at concentrations in a range of from about 0.35 g/L (gram per liter of aqueous solution) to about 0.85 g/L. The protease may be present in the EICP solution at a concentration in a range having a lower limit of any one of 0.35 g/L, 0.38, 0.40, 0.42, 0.45, 0.5, 0.55, and 0.6 g/L and an upper limit of any one of 0.55, 0.58, 0.60, 0.62, 0.65, 0.70, 0.75, 0.80 and 0.85 g/L, where any lower limit can be paired with any mathematically compatible upper limit.

### Treatment Composition

In another aspect, embodiments herein relate to a treatment composition to reduce the concentration of ions in produced water. The treatment composition may include an EICP solution and an amount of produced water. The EICP solution may be as described above. In particular embodiments, the produced water includes one or more metal cations. In such embodiments, the one or more metal cations are dissolved in the produced water. A source of the one or more metal cations dissolved in the produced water may be a formation rock of a reservoir, such that the produced water carries or dissolves a metal cation from a rock of the formation to a surface of the reservoir.

The EICP solution and the produced water may be present in the treatment composition at a ratio in a range from about 1:4.2 to about 1:3.8. In one or more particular embodiments, the EICP solution and the produced water is present in the treatment composition at a ratio of about 1:4.

The produced water may include at least one of freshwater, seawater brine, water-soluble organic compounds, water-insoluble materials, and mixtures thereof produced from a reservoir. The produced water may contain wastewater containing various salts. The salts dissolved in the produced water may also cause sulfate scale formation such that the salts of the produced water may be at least one metal cation capable of forming sulfate scale, carbonate precipitate, or combinations thereof. The salts in the produced water may include, but are not limited to, one or more selected from alkali earth metal cations, such as sodium (Na⁺), potassium (K⁺), and lithium (Li⁺), and alkaline earth metal cations, such as barium (Ba²⁺), calcium (Ca²⁺), and strontium (Sr²⁺).

The produced water may include at least one cation, which may be a metal cation. The at least one cation may include at least one alkali earth metal cation, at least one alkaline earth metal divalent cation, one or more transition metal cations, or combinations thereof. The produced water may include an alkali earth metal cation, an alkaline earth metal cation, or both dissolved in the produced water from the formation rock of the reservoir. The alkaline earth metal cations may include one or more cations selected from the group consisting of calcium cations, barium cations, strontium cations, and combinations thereof.

Calcium cations may be dissolved in the produced water in a concentration range with a lower limit lower limit from about 500 ppm (parts per million), 550, 600, 1000, 2,000, 3,000, 4,500, 5,000, 7,500, 10,000, 12,500, or 15,000 ppm and an upper limit of about 1,000 ppm, 5,000, 10,000, 15,000, 17,500, 20,000, 22,500, or 25,000 ppm, where any lower limit can be paired with any mathematically compatible upper limit.

Magnesium cations may be dissolved in the produced water in a concentration range with a lower limit from about 1,000, 1,250, 1,500, 1,750, 2,000, or 2,500 ppm to an upper limit of about 2,000, 2,250, 2,500, 2,750, 3,000, 3,500, or 4,000 ppm, where any lower limit can be paired with any mathematically compatible upper limit. Strontium cations may be dissolved in the produced water in a concentration range with a lower limit from about 5, 7.5, 9, and 10 ppm to an upper limit of about 50, 75, 80, 90, 95, 99, and 100 ppm, where any lower limit can be paired with any mathematically compatible upper limit. Sodium cations may be dissolved in the produced water in a concentration range with a lower limit from about 1,000, 1,250, 1,500, 1,750, 2,000, or 2,500 ppm to an upper limit of about 2,000, 2,250, 2,500, 2,750, 3,000, 3,500, or 4,000 ppm, where any lower limit can be paired with any mathematically compatible upper limit. Potassium cations may be dissolved in the produced water in a concentration range with a lower limit from about 1,000, 1,250, 1,500, 1,750, 2,000, or 2,500 ppm to an upper limit of about 2,000, 2,250, 2,500, 2,750, 3,000, 3,500, or 4,000 ppm, where any lower limit can be paired with any mathematically compatible upper limit.

As one of ordinary skill may appreciate, the produced water may include one or more anions, the concentration of which may vary from one produced water to another and if recovered from different reservoirs. For example, the produced water may include chloride ions, sulfate ions, or combinations thereof. In some embodiments, the produced water includes chloride ions in a concentration range having a lower limit of any one of about 5,000, 7,500, 10,000, 12,500, 15,000, and 20,000 ppm and an upper limit of about 20,000, 22,500, 25,000, 30,000, 32,000, and 35,000 ppm, where any lower limit can be paired with any mathematically compatible upper limit. Sulfate anions may be present in the produced water in a concentration range with a lower limit of any one of about 1,500, 1,750, 2,000, 2,500, and 3,000 ppm to an upper limit of any one of about 3,000, 3,500, 4,000, 4,500, and 5,000 ppm, where any lower limit can be paired with any mathematically compatible upper limit.

The salinity, oil content, total dissolved solids, and pH of the produced water recovered from a reservoir can vary from one reservoir to another. The term “total dissolved solids” or “TDS” means a measure of the dissolved combined content of all inorganic and organic substances present in a liquid in molecular, ionized, or micro-granular (colloidal sol) suspended form. Unless indicated otherwise, TDS concentrations are reported in parts per million (ppm). In one or more embodiments, the produced water may have a total dissolved solids content in an amount of at least 50,000 ppm, 55,000 ppm, or at least 60,000 ppm, or at least 70,000 ppm, or at least 80,000 ppm, or at least 100,000 ppm, or at least 200,000 ppm.

The term “hardness” means a measure of the dissolved calcium carbonate equivalent per unit volume of liquid, more generally, water hardness is a measure of the amount of calcium and magnesium salts in water. Hardness concentrations may be reported in milligrams of calcium carbonate equivalent per liter of liquid (mg/L) or parts per million (ppm). In one or more embodiments, the produced water may have a hardness content in an amount of at least 500 ppm, 1000 ppm, 2,500 ppm, or at least 5,000 ppm, or at least 7,000 ppm, or at least 8,000 ppm, or at least 9,000 ppm, or at least 10,000 ppm.

The term “total salt content” means a measure of the water-soluble chemical compound consisting of an ionic assembly of a positively charged metal cation and a negatively charged anion, which results in a compound with no net electric charge. Total salt content is often reported in parts per million (ppm). In one or more embodiments, the produced water may have total salt content in an amount of at least 10,000 ppm, or at least 25,000 ppm. or at least 50,000 ppm, or at least 75,000 ppm. In such embodiments, the produced water may be defined as “a high salinity produced water”, where the high salinity produced water has a salt content of at least 100,000 ppm.

### System for Reducing Ionic Content of a Produced Water

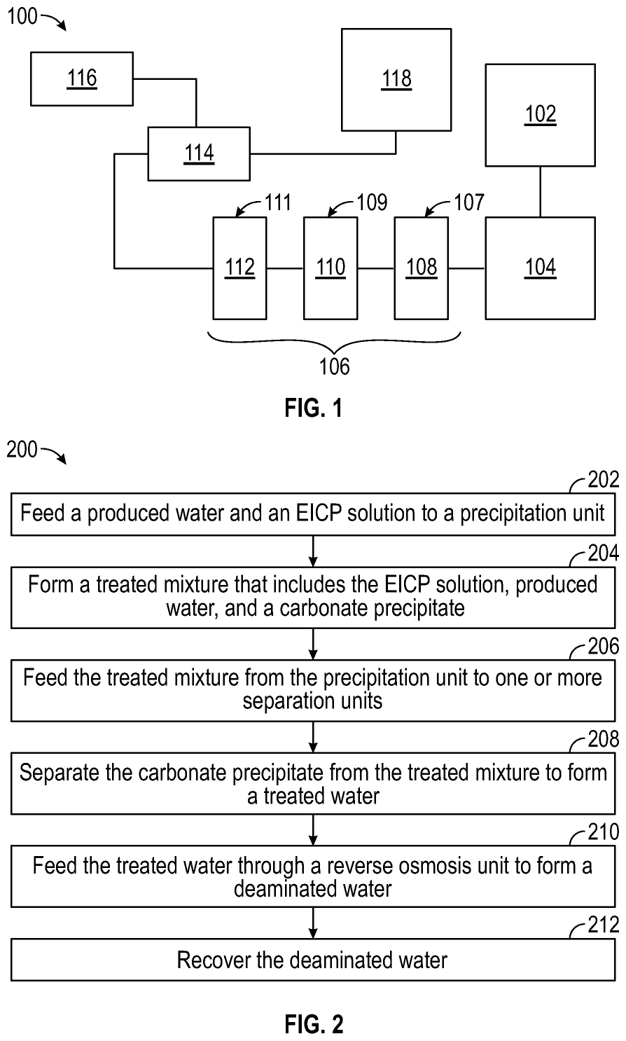

In another aspect, embodiments herein relate to a system for reducing an ionic content of a produced water. The system may include a precipitation unit configured to form a treatment mixture via the precipitation of one or more ions from the produced water in the presence of an EICP solution. The precipitate of the treatment mixture may include a carbonate precipitate. The produced water and the EICP solution may be as described above. A non-limiting example of a treatment system may be as shown in FIG. 1. As shown in FIG. 1, the system 100 may include a precipitation unit 102 in fluid communication with a treatment mixture holding unit 104. The treatment mixture holding unit 104 may be in fluid communication with one or more separation units 106. The precipitation unit 102 may be configured to receive a first solution and a second solution that are combined or mixed in the precipitation unit to form the EICP solution. In some embodiments, the precipitation unit is configured to receive one or more fluids to form the EICP solution.

In some embodiments, the treatment system may include a treatment mixture holding unit 104. The treatment mixture holding unit 104 may be in fluid communication with and downstream of the precipitation unit. The treatment mixture holding unit 104 may be configured to store a treatment mixture, which includes produced water that has been treated with the EICP solution. In some embodiments, the treatment mixture holding unit is a holding tank. In one or more particular embodiments, the treatment mixture stored in the treatment mixture holding unit 104 has a high concentration of ammonia as compared to the concentration of ammonia in the produced water. In particular embodiments, the treatment mixture has a concentration of ammonia above 30 ppm, such as about 33 ppm, dissolved in the liquid phase of the treatment mixture. In such embodiments, the liquid phase of the treatment mixture having an ammonia concentration above 30 ppm can be subjected to a reverse osmosis treatment to reduce the ammonia concentration of the treatment mixture.

The system may include one or more separation units 106 downstream of and in fluid communication with the treatment mixture holding unit 104. The one or more separation units 106 may be configured to separate the precipitate, one or more components of the EICP solution, one or more additional impurities, or combinations thereof from the treatment mixture to form a treated water. The one or more separation units 106 may include at least one treatment stage. In such embodiments, the system includes one separation unit. The one or more separation units 106 may include at least two treatment stages. In such embodiments, the system includes at least two separation units.

As shown in FIG. 1, the one or more separation units 106 may include at least three treatment stages (e.g., stages 107, 109, and 111) each having at least one separation unit (e.g., units 108, 110, and 112). For example, the system 100 may include a treatment mixture holding unit 104 that is in fluid communication with a first treatment stage 107 having a first separation unit 108. The first separation unit 108 of the first treatment stage 107 may be configured to remove mechanical impurities, such as sediment, sand, or both, from the treatment mixture to form a second treatment mixture. The second treatment mixture may be fed to a second treatment stage 109 in fluid communication with the first treatment stage 107. The second treatment stage 109 may have a second separation unit 110. The second separation unit 110 of the second treatment stage 109 may be configured to remove chlorine and organic compounds from the first treatment mixture to form a second treatment mixture. The second treatment stage 109 may be in fluid communication with a third treatment stage 111 such that the second treatment mixture is fed from the second separation unit 110 to a third separation unit 112 of the third treatment stage 111. The third separation unit 112 may be configured to provide fine purification of the second treatment mixture to form a third treatment mixture.

In one or more embodiments, the system 100 includes a reverse osmosis unit 114 downstream of and in fluid communication with the one or more separation units 106. In such embodiments, the reverse osmosis unit 114 is configured to receive a treated water from the one or more separation units 106. The reverse osmosis unit 114 may include a reverse osmosis membrane (not shown). The reverse osmosis membrane may be a hydrophobic membrane adapted to selectively remove one or more small molecules from the treated water. The one or more small molecules may include ammonia. In such embodiments, the reverse osmosis unit 114 is configured to produce a deaminated water from the treated water fed to the reverse osmosis unit 114. A small molecule storage unit 116 may be in fluid communication with the reverse osmosis unit 114 to collect separated small molecules. The small molecule storage unit 116 may be an ammonia storage unit. The deaminated water produced from the reverse osmosis unit 114 may be recovered in a water storage unit 118. The water storage unit 118 may be downstream of and in fluid communication with the reverse osmosis unit 114. As one of ordinary skill may appreciate, the system 100 may include one or more components including, but not limited to, pumps, fluid flow sensors, temperature sensors, among other components. System 100 may include mixers, vessels, settling tanks, clarifiers, separators, pumps, piping, controls, and the like, to remove precipitate and ions from produced water.

In some embodiments, the second separation unit 110, the third separation unit 112, or both include a carbon filter. The first separation unit 108 may include one or more units configured to separate (i.e., “separators”) mechanical impurities, such as solids from the treatment mixture. One of ordinary skill will appreciate that the separators may be configured to separate mechanical purities via centrifugation, gravity filtration, among other mechanisms.

### Method for Reducing Ionic Content of a Produced Water

One or more embodiments of the present disclosure relate to a method for reducing an ionic content of produced water. The method of one or more embodiments may allow for the treatment and recycling of produced water for use in one or more upstream oil and gas processes, such as hydraulic fracturing. In one or more particular embodiments, the concentration of metallic cations, anions (e.g., sulfate anions), or both of produced water may be reduced by treatment of the produced water in accordance with a method described herein.

The method of one or more embodiments may include one or more of a treatment composition, a system for reducing the ionic content of a produced water, or both. The treatment composition and the system may be as described above. As a non-limiting example, the method for reducing the ionic content of a produced water in accordance with one or more embodiments may include treating a produced water with an aqueous EICP solution in a system, where the produced water may be introduced to the EICP solution to form a treatment composition. In some embodiments, the EICP solution may be introduced to the produced water to form the treatment composition. The treatment composition may be formed in the precipitation unit of a system (e.g., system 100 as described in FIG. 1).

A non-limiting method 200 for reducing the ionic content of a produced water may be as shown in FIG. 2. In block 202, produced water and an EICP solution are fed to the precipitation unit such that a treated mixture including a carbonate precipitate forms in the precipitation unit. The produced water may be fed to the precipitation unit after recovery from a formation (e.g., a hydrocarbon-bearing reservoir). In one or more particular embodiments, the produced water is pre-processed after recovering the produced water from the formation and prior to treatment to reduce the ionic content of the produced water. Pre-processing the produced water may include de-oiling, which includes separation of the aqueous produced water from any produced hydrocarbon contaminants. The EICP solution may be introduced to the produced water such that the EICP solution is added to the produced water in a holding unit. Alternatively, the produced water may be introduced to the EICP solution such that the produced water is added to an EICP solution in a holding unit. In some embodiments, one or more ions of the produced water and one or more components of the EICP solution react to form a treated mixture including a carbonate precipitate.

In some embodiments, the EICP solution is introduced into the precipitation unit as one solution. In some embodiments, the EICP solution is introduced into the precipitation unit as two or more solutions. For example, a first solution and a second solution may be introduced to the precipitation unit such that the EICP solution is a combination of a first solution and a second solution. In such embodiments, the first solution includes urea, one or more polysaccharides, casein protein, protease, and an ionic compound. The second solution may include a urease.

In block 204, method 200 includes forming a carbonate precipitate via reaction of a treatment composition including a produced water and an EICP solution. The carbonate precipitate formed via reaction of the treatment composition may be formed in a precipitation unit of a system (e.g., system 100 as described in FIG. 1).

In some embodiments, the reaction of the treatment composition is conducted for at least 18 hours, at least 20 hours, or at least 24 hours in a precipitation unit. In some embodiments, the reaction is conducted at a temperature in a range from 15° C. to 75° C. For example, the reaction may be conducted at a temperature in a range having a lower limit of any one of 15, 20, 25, 30, 35, 40, and 45° C. and an upper limit of any one of 50, 55, 60, 65, 70, and 75° C., where any lower limit can be paired with any mathematically compatible upper limit. In some embodiments, the temperature of the reaction conditions may not exceed about 70° C. or about 75° C. such that the denaturation of enzymes in the treatment composition is prevented.

The EICP process of one or more embodiments is an in situ chemical reaction that may be a useful part of a method for effecting treatment of produced water. EICP employs a urease enzyme to catalyze the hydrolysis of urea in an aqueous solution. EICP in the presence of divalent ions generates ammonium ions and a carbonate mineral that precipitates out of the aqueous solution. For example, in the presence of calcium ions, the EICP process results in calcium carbonate (CaCO₃) precipitate as shown in Equation 1:

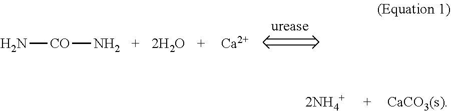

Mineral precipitation may include one or more cations present in the produced water that may produce one or several phases of carbonate mineral precipitate, including, but not limited to, barite, struvite, calcite, halite, nesquehonite, or combinations thereof. The byproducts of the reaction are CO₂ and ammonia. The method for reducing the ionic concentration of a produced water described in one or more embodiments herein takes advantage of the supply of carbonate ions derived from urea hydrolysis and an increase in pH generated by the reaction. The increase in pH generated by the reaction may be a result of the formation of ammonia in the treatment composition. For example, the production of hydroxide ions from ammonia reaction with water molecules brings about an increase in pH, which in turn leads to the formation of carbonate ions from the produced CO₂. The produced CO₂ dissolves in water to form carbonic acid and bicarbonate ion. This increases the pH level, which favors bicarbonate ions reaction with free ions in the solution to form carbonates. For instance, urease mediated urea hydrolysis reaction in the presence of calcium ions, precipitates calcium carbonate.

The EICP process may be triggered by the catalytic action of an enzyme in the hydrolysis of urea. For example, EICP in accordance with one or more embodiments is a method of carbonate precipitation via hydrolysis of urea employing urease enzyme. One or more components of the EICP solution may stabilize the urease enzyme and act as nucleation point for ions, thereby enhancing ionic precipitation from produced water. The method of one or more embodiments utilizes the urease enzyme to catalyze the hydrolysis of urea (urcolysis) in an aqueous solution including metallic ions (e.g., produced water as described above), and promotes the formation of carbonate precipitates (e.g., calcium carbonate precipitates, magnesium carbonate precipitates, among others). The chemical composition of the EICP solution may provide nucleation sites that favor carbonate precipitate formation. The increase in the number of nucleation sites allows for the enhanced precipitation of ions. Accordingly, the method of contacting a produced water with an EICP solution may provide for the formation of a treatment mixture that includes a reduced ionic content of the produced water and a carbonate precipitate.

One or more metal cations dissolved in the produced water may react with one or more components of the EICP solution. Reaction of the one or more metal cations with one or more components of the EICP solution may form a carbonate salt having a low solubility in aqueous solution such that the carbonate salt precipitates from the treatment composition to produce the treatment mixture. The treatment composition may be capable of carbonate precipitate formation and co-precipitation of metal ions with one or more additional ions present in produced water, such as sulfate, chloride, among others. The reaction of ions in the produced water with one or more components of the EICP solution may form a treated mixture. The treated mixture may include the treatment composition and one or more carbonate precipitates. In some embodiments, the treated mixture includes the treatment composition, one or more carbonate precipitates, and one or more co-precipitates.

Block 206 of method 200 may include feeding the treated mixture from the precipitation unit to one or more separation units. The separation units may be as described above. In some embodiments, the method includes separating the precipitate, one or more components of the EICP solution, one or more additional impurities, or combinations thereof from the treated mixture in the one or more separation units to form a treated water. The one or more separation units may separate the precipitate from the treated mixture. The one or more separation units may separate the EICP solution from the treated mixture. The one or more separation units may separate one or more additional impurities from the treated mixture.

In some embodiments, the treated mixture is separated by the one or more separation units such that a treated water having a reduced concentration of ions as compared to the produced water is formed (e.g., block 208 of method 200). In one or more embodiments, the treated water includes the aqueous fluid from the produced water. The treated water may have a lower ionic concentration as compared to an untreated produced water. The treated water may be injected into a formation, thereby recycling the produced water.

In one or more embodiments, the treated water obtained from the one or more separation units includes a high concentration of ammonia as compared to the ammonia concentrations of the EICP solution and the untreated produced water. In such embodiments, the treated water is processed to decrease the concentration of ammonia or to remove ammonia, thereby forming a deaminated water. In particular embodiments, the treated water can be fed to a reverse osmosis unit that includes a reverse osmosis membrane filter as shown in block 210. The reverse osmosis unit may be configured to selectively reduce the concentration of small molecules from a treated water having less than 80,000 mg/L. In such embodiments, the treated water having less than 80,000 mg/L is considered a non-scaling water.

The treated water may be fed through the reverse osmosis membrane filter to remove ammonia from the treated water to form a deaminated water. In some embodiments, the reverse osmosis membrane filter may be adapted to selectively reduce the concentration of small molecules including, but not limited to, ammonia, from the treated water. The separated ammonia byproduct may be recovered in a small molecule storage unit. In block 212, the water separated from the ammonia byproduct may be recovered. The water separated from the ammonia byproduct (i.e., the deaminated water) may be recovered in a water storage unit. In some embodiments, the deaminated water may be used in one or more oil and gas operations after recovery from the reverse osmosis unit. Optionally, the deaminated water may be transferred from the water storage unit to a surface location of a formation, where the deaminated water may be used for injection into the formation.

The deaminated water, the treated water, or both may have a concentration of ions that is less than the produced water prior to treatment. For example, the untreated produced water may have a TDS concentration of 5% or more as compared to a TDS concentration of a deaminated water, a treated water, or both. Thus, the deaminated water, the treated water, or both may have a reduced TDS concentration of 5% or less than the TDS concentration of the untreated produced water. In some embodiments, the TDS concentration of the deaminated water, the treated water, or both is about 100 mg/L (milligrams per liter) or less. The deaminated water, the treated water, or both having a TDS concentration of about 100 mg/L or less may be suitable for use in one or more oil and gas operations, such as one or more downhole operations. Embodiments in which the deaminated water, the treated water, or both has a TDS concentration of greater than 100 mg/L, the deaminated water, the treated water, or both may be subjected to one or more steps of the EICP treatment process, such that the EICP process may be repeated to achieve a TDS concentration of about 100 mg/L or less.

In some embodiments, the total content of sodium ions, potassium ions, calcium ions, magnesium ions, barium ions, strontium ions, copper ions, silicon, phosphorous, iron ions, among other ions of a produced water sample, a treated water sample, a deaminated water sample, or combinations thereof is determined by Inductively Coupled Plasma equipped with Optical Emission Spectroscopy (ICP-OES). Analysis of a produced water, a treated water, a deaminated water, or combinations thereof may include injecting an aliquot of a water sample to the ICP-OES equipment. In one or more particular embodiments, a sample of a produced water, a treated water, a deaminated water, or combinations thereof is analyzed with a defined SALAM method. The SALAM method may include filling a cooler coupled to the ICP-OES system with deionized water to a maximum line, ensuring a fume or exhaust hood is in operation, and activating an argon gas supply to the ICP-OES equipment. When a pressure cylinder of the argon supply reads 2000 psi (pounds per square inch) and an ICP pressure valve reads 90 psi, a computer coupled to the ICP-OES equipment may be powered on. Software for ICP-OES analysis (e.g., ICP 5.4 ACTIVA) may be activated to begin ICP-OES experiments. A nebulizer tube may be placed into a beaker filled with deionized water, and elements, concentrations, and wavelengths may be input into the software. If a new calibration is being performed, a default concentration option may be selected from the base of elements included in the software. The elements in the solution may then be profiled and peaks identified using measured standards, data included in an existing dataset of the software, or both. The highest standards may be used to search and identify peaks.

### Method of Treating a Reservoir

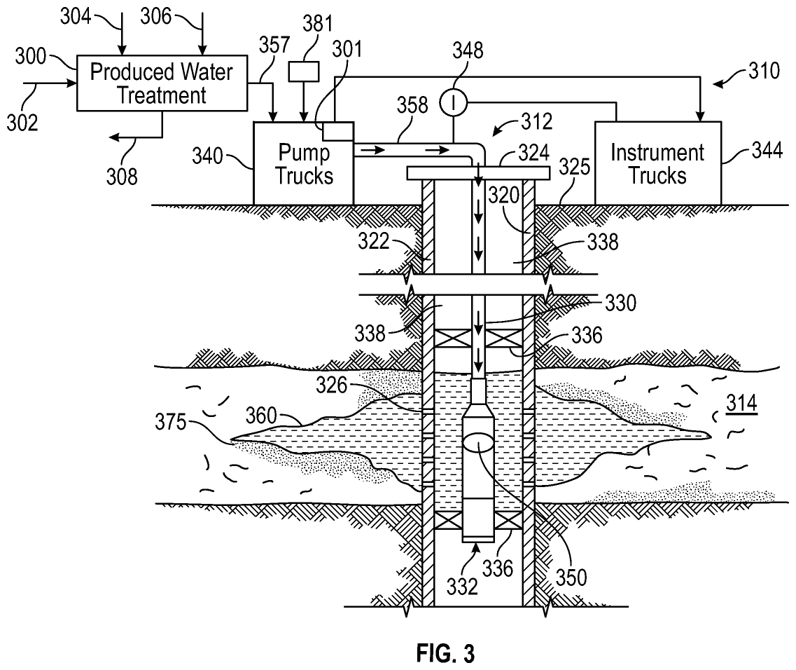

As one of ordinary skill in the art may appreciate, embodiments described herein may be used for any number of oil and gas operations. Such operations may include enhanced oil recovery, matrix stimulation, fracturing and drilling, among others. A particular embodiment is described in FIG. 3, in which produced water treatment is combined with a fracturing operation.

FIG. 3 illustrates an example of a reservoir treatment 310 for well 312. Well 312 may be in a wellbore 320 formed in a subterranean zone 314 of a geological formation in the Earth's crust. Subterranean zone 314 may include, for example, a formation, a portion of a formation, or multiple formations in a hydrocarbon-bearing reservoir from which recovery operations can be practiced recovering trapped hydrocarbons. In some implementations, subterranean zone 314 includes an underground formation of naturally fractured rock containing hydrocarbons (for example, oil, gas, or both). In some embodiments, well 312 may intersect other suitable types of formations, including reservoirs that are not naturally fractured in any significant amount.

Well 312 can include one or more instrument trucks 344, one or more surface sensors 348, one or more downhole sensors 350, a casing 322 and well head 324. Wellbore 320 may be a vertical, horizontal, deviated, or multilateral bore. Perforations 326 may be present in casing 322 to allow for flow of oil, gas, byproduct, or combinations thereof into the well. Casing 322 may be cemented or otherwise suitably secured in wellbore 320. For a treatment 310, a work string 330 can be disposed in the wellbore 320. Work string 330 may be coiled tubing, sectioned pipe, or other suitable tubing. A drilling tool 332 may be coupled to an end of the work string 330. Packers 336 may seal an annulus 338 of wellbore 320 uphole of and downhole of subterranean zone 314.

One or more pump trucks 340 with one or more pump controls 301 may be coupled to work string 330 at the surface 325. The pump trucks 340 pump fracture fluid 358 down work string 330 to perform the fracture treatment 310 and generate the fracture 360. Fracture 360 is generated in rock 375 of subterranean zone 314. The fracture fluid 358 may include a fluid pad, proppants, flush fluid, or a combination of these components. Fracture fluid 358 may include deaminated water produced by one or more methods described above, treated water produced by one or more method described above, or both. The pump trucks 340 may include mobile vehicles, equipment such as skids, or other suitable structures. The pump trucks 340 may be in fluid communication with a system 300 such that the pump trucks receive a treated produced water, a deaminated produced water, or both from the system 300. In some embodiments, one or more additives may be transported from unit 381 to the pump trucks 340 such that the one or more additives are combined with the treated produced water, the deaminated produced water, or both to form a suitable fracturing fluid.

In one or more embodiments, the reservoir treatment 310 includes a system 300 for reducing the ionic content of a produced water that receives and treats a produced water to prepare the deaminated water, treated water, or both as a base fluid 357 in the treatment fluid 358. System 300 includes equipment to remove ions from the produced water according to methods of the present disclosure. For example, system 300 may include fluid injection lines 302, 304, and 306 for injection of one or more fluid components of the treatment composition. Fluid line 308 may be an outlet line for the removal of a precipitate, one or more components of the EICP treatment solution, or both. System 300 may be as described above and as shown in FIG. 1. Indeed, in operation, the system 300 recycles produced water by reducing the ionic content of the produced water via formation of carbonate precipitates with ions (e.g., metallic ions) present in the produced water and an EICP solution.

Embodiments of the present disclosure may provide at least one of the following advantages. The method of contacting a produced water with an EICP solution may provide for reduction in ionic content of the produced water. The produced water having a reduced ionic content may be recycled for upstream oil and gas processes, such as hydraulic fracturing. In such cases, the recycling of produced water reduces the cost of disposing of the produced water. Additionally, the use of treated produced water in one or more embodiments may address the shortage of water supply on-site in oil and gas reservoirs.

### EXAMPLES

The following examples are merely illustrative and should not be interpreted as limiting the scope of the present disclosure.

### Methods: EICP Treatment

EICP treatment of the produced water included adding an aqueous EICP treatment solution to the produced water. The aqueous EICP treatment solution included a 0.5 M (molar) concentration of urea, a 0.6 M concentration of ionic compound, 2 g/L of Jack Bean urease, a 0.5 M concentration of a polysaccharide, 4 g/L of casein protein, a 0.4 M concentration of a sucrose derivative sugar, and a 0.4 M concentration of Aminogen® protease. (0.4 M). The produced water is a formation water containing crude oil and was recovered from an oil producing well. Urea, calcium chloride, Jack Bean urease, xanthum gum, casein protein, sucrose, and protease (Aminogen®) were obtained from Sigma-Aldrich.

The produced water and the aqueous EICP treatment solution were mixed and allowed to react. Precipitate formation was observed at 48 hours of reaction time. The precipitate was separated and isolated. Residual water was removed from the precipitate by oven drying.

### Methods: Inductively Coupled Plasma-Optical Emission Spectroscopy Analyses

Geochemical analysis and ionic concentration of produced water samples before and after EICP treatment were studied.

Analyses of an untreated produced water sample and a sample of the produced water treated with an EICP solution (i.e., a treated water) included the determination of the total content of sodium ions, potassium ions, calcium ions, magnesium ions, barium ions, strontium ions, copper ions, silicon, phosphorous, and iron ions of a produced water sample by Inductively Coupled Plasma equipped with Optical Emission Spectroscopy (ICP-OES) in each of the untreated and treated samples. The ICP-OES sample preparation for each of the untreated and treated samples included filtration of the sample through a 0.45 μm (micrometer) membrane filter and addition of nitric acid addition. This ICP-OES treatment was performed on both untreated and treated produced water samples, standards, and quality control samples such that each sample had a pH value <2 as based on the defined SALAM method.

An aliquot of a produced sample (both before and after treatment) was injected into an ion chromatograph. The sample was pumped through two columns, a suppressor device, and into a conductivity detector. The analytical column and the guard column were packed with anion exchange resin. Ions were separated based on their affinity for the exchange sites of the resin. The suppressor device contained a fibre- or membrane-based cation exchanger that was continuously regenerated by a flow of dilute electrolytic suppressor. The suppressor device reduced the background conductivity of the eluent to a low or negligible level by replacing the cations with the hydrogen ion, thereby converting the anions in the sample to their corresponding acids. The separated anions in their acid form are measured using an electrical-conductivity cell. Anions were identified based on their retention times compared to known standards. Quantification was accomplished by measuring the peak height or area and comparing it to a calibration curve generated from known standards.

### Methods: Specific Gravity

A small volume, approximately 1 mL (milliliter) to 2 mL, of each liquid sample was introduced into an oscillating sample tube, and the change in oscillating frequency caused by the change in the mass of the tube was used in conjunction with calibration data to determine the specific gravity of the sample.

### Methods: Chloride Analysis

The sample was titrated with a standard silver nitrate solution to precipitate silver chloride. A titration curve was plotted with Mettler DL-77 software by recording the titrant volume required to reach the equivalent point of the titration using the silver chloride ring electrode.

### Methods: Total Dissolved Solids

Total Dissolved Solids (TDS) was calculated from the sum of the experimental tested cations and anions results.

### Results

Results presented in Table (1) indicated a reduction in concentration of about 50% for each of the constituents after the enzyme treatment without a significant change in the specific gravity of the sample.

TABLE 1
Ionic sample content analyses in milligrams per
Liter (mg/L) of produced water before treatment
(Sample A) and after treatment (Sample B)

| Constituents | Sample A (mg/L) | Sample B (mg/L) |
|---|---|---|
| Barium (Ba²⁺) | <1 | <1 |
| Calcium (Ca²⁺) | 659 | 320 |
| Chloride (Cl⁻) | 31944 | 18036 |
| Magnesium (Mg²⁺) | 1859 | 1022 |
| Potassium (K⁺) | 764 | 455 |
| Sodium (Na⁺) | 15987 | 9273 |
| Specific Gravity @ 60 | 1.0418 | 1.0329 |
| F. | | |
| Strontium (Sr²⁺) | 10 | 5 |
| Sulfate (SO₄²⁻) | 4383 | 2364 |
| Total Dissolved Solids | 55607 | 31476 |

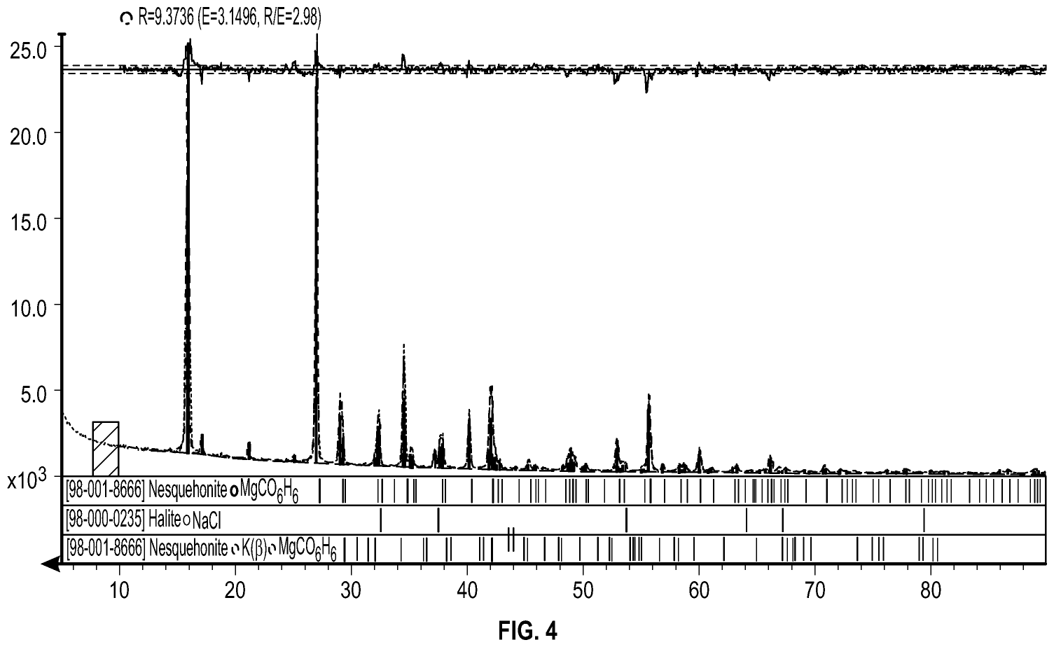

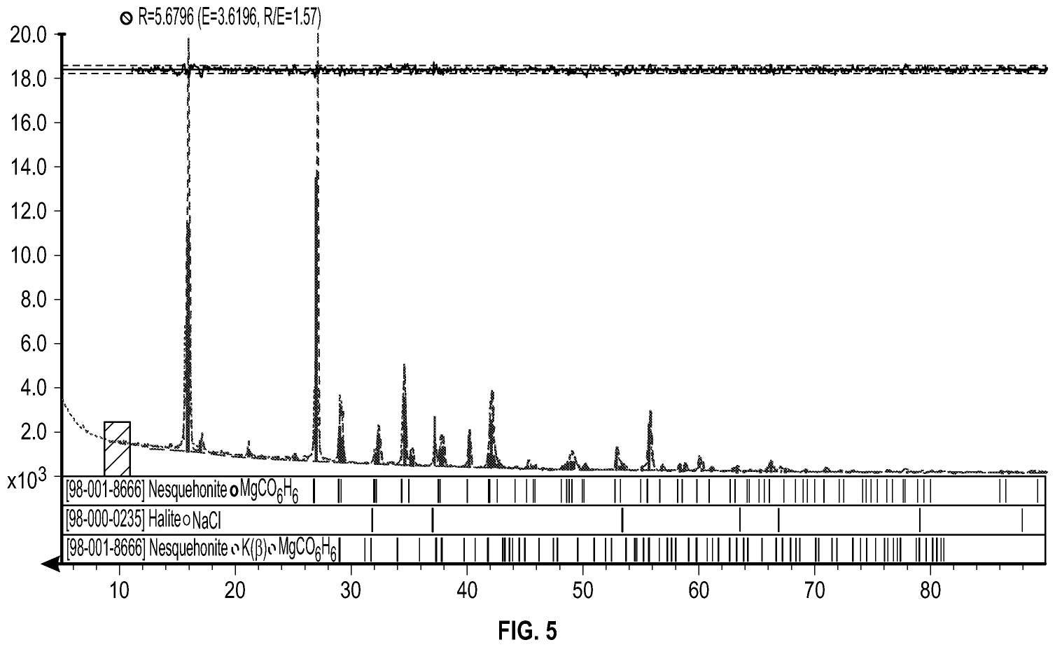

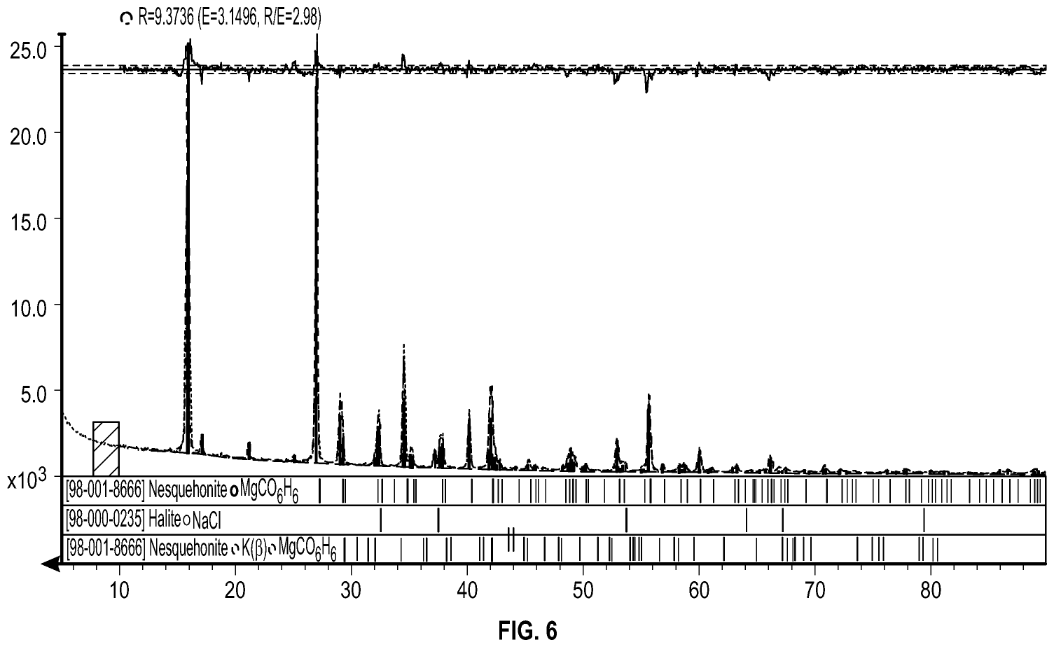

X-ray Diffraction (XRD) was employed for the characterization of the precipitates obtained from three water samples post-treatment. Treatment for each of the three water samples may be as described above. XRD spectra for precipitates obtained from each of the three water samples post-treatment are presented in FIGS. 4-6 together with the corresponding identification.

According to the results shown in FIGS. 4-6, all three samples contain magnesium carbonate trihydrate (nesquehonite [MgCO₃×3 H₂O]) together with salt (Halite [NaCl]). The patterns are identical in terms of peaks present, and evidence the presence of magnesium carbonate trihydrate (nesquehonite [MgCO₃×3 H₂O]) together with salt (Halite [NaCl]). Quantitative data are presented in Table 2.

TABLE 2
Quantitative phase analysis for precipitate samples of FIGs. 4-6

| | #1 | #2 | #3 |
|---|---|---|---|
| Compound | (wt %) | (wt %) | (wt %) |
| Nesquehonite | 94.7 | 98.5 | 98.3 |
| [MgCO3 × | | | |
| 3H2O] | | | |
| Halite [NaCl] | 5.3 | 1.5 | 1.7 |

As shown in Table 2, nesquehonite was the predominant precipitate formed during treatment of the produced water and halite was formed as a co-precipitate. These results, along with results shown in Table 1, indicates that the method of treating a produced water with an EICP solution according to embodiments herein are successful in providing a mechanism for recycling produced water for use in upstream oil and gas operations.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method of reducing an ionic content of a produced water, the method comprising:
forming a carbonate precipitate in a precipitation unit via reaction of a treatment composition comprising produced water and an EICP solution, thereby producing a treated mixture,
wherein metal cations dissolved in the produced water react with one or more components of the EICP solution thereby forming the carbonate precipitate.

2. The method of claim 1, wherein the EICP solution comprises urea, one or more polysaccharides, a casein protein, a protease, an ionic compound, and a urease.

3. The method of claim 1, wherein the reaction of the treatment composition produces an ammonia byproduct dissolved in a liquid phase of the treated mixture.

4. The method of claim 3, further comprising:
feeding the treated mixture from the precipitation unit to one or more separation units;
separating the carbonate precipitate, the treatment composition, one or more additional impurities, or combinations thereof from the treated mixture in the one or more separation units to form a treated water.

5. The method of claim 4, further comprising injecting the treated water into a formation, thereby recycling the produced water.

6. The method of claim 4, further comprising:
reducing an ammonia byproduct concentration of the treated water by feeding the treated water through a reverse osmosis unit comprising a reverse osmosis filter to form a deaminated water.

7. The method of claim 6, wherein the reverse osmosis filter is adapted to selectively remove ammonia from the treated water.

8. The method of claim 6, further comprising:
recovering the ammonia byproduct in an ammonia storage unit;
recovering the deaminated water in a water storage tank; and
optionally, transporting the deaminated water from the water storage tank to a surface location of a formation for injection into the formation.

9. The method of claim 1, further comprising:
prior to the forming the carbonate precipitate, adding an amount of the produced water to the EICP solution in the precipitation unit.

10. The method of claim 1, wherein the reaction of the treatment composition is conducted for at least 24 hours at a temperature in a range from 15° C. to 75° C.

11. The method of claim 1, further comprising:
prior to forming the carbonate precipitate, introducing a first solution and a second solution separately to the precipitation unit; and
combining the first solution and the second solution to form the EICP solution, where the first solution comprises urea, one or more polysaccharides, casein protein, protease, and an ionic compound, and where the second solution comprises a urease.

12. The method of claim 1, wherein the EICP solution is introduced into the precipitation unit as one solution.

13. A system for reducing an ionic content of a produced water, the system comprising:
a precipitation unit configured to form a treated mixture via precipitation of one or more ions from the produced water in the presence of an EICP solution; and
one or more separation units in fluid communication with the precipitation unit and configured to separate a precipitate, the EICP solution, one or more additional impurities, or combinations thereof from the treated mixture.

14. The system of claim 13, further comprising:
a reverse osmosis unit downstream of and in fluid communication with the one or more separation units.

15. The system of claim 14, wherein the reverse osmosis unit comprises a reverse osmosis membrane adapted to selectively remove ammonia from the treated mixture.

16. The system of claim 13, wherein the EICP solution comprises urea, one or more polysaccharides, casein protein, protease, an ionic compound, and a urease.

17. The system of claim 16, where the one or more polysaccharides are selected from xanthan gum, guar gum, or combinations thereof.

18. The system of claim 16, where the casein protein comprises a micellar casein protein.

19. The system of claim 16, where the ionic compound comprises sodium chloride.
